(19) United States
(12) Patent Application Publication
(10) Pub. No.: US 2026/0290220 A1
(43) Pub. Date: Sep. 24, 2026

(54) OVER DRIVING CIRCUIT AND DISPLAY DEVICE INCLUDING THE SAME

(71) Applicant: LX SEMICON CO., LTD., Daejeon (KR)

(72) Inventors: Tae Hoon KIM, Daejeon (KR); Do Seok KIM, Daejeon (KR)

(73) Assignee: LX SEMICON CO., LTD., Daejeon (KR)

(21) Appl. No.: 19/570,574

(22) Filed: Mar. 18, 2026

(30) Foreign Application Priority Data
Mar. 21, 2025 (KR) 10-2025-0036469

(51) Int. Cl. G09G 3/20

(52) U.S. Cl. CPC G09G 3/2092; G09G 2320/0242; G09G 2340/02; G09G 2340/06; G09G 2340/16; G09G 2360/16

(57) ABSTRACT

An over driving circuit for a display device includes an encoder configured to generate first compressed data obtained by compressing RGB image data of a previous frame using a first compression algorithm, and to generate second compressed data obtained by compressing the RGB image data using a second compression algorithm; a reconstructor configured to select one of the first compressed data and the second compressed data and to synthesize the selected compressed data to generate one piece of integrated compressed data; a decoder configured to reconstruct the generated integrated compressed data to generate integrated reconstructed data; and a modulator configured to modulate image data of a current frame using the generated integrated reconstructed data.

### CROSS REFERENCE TO RELATED APPLICATION

This application claims the priority of Korean Patent Application No. 10-2025-0036469, filed on Mar. 21, 2025, which is hereby incorporated by reference in its entirety.

### BACKGROUND

### Field of the Disclosure

The present disclosure relates to an over driving circuit and a display device including the same.

### Description of the Background

As the information society has advanced, demand for display devices capable of presenting images in various forms has increased. In recent years, diverse types of display devices, such as liquid crystal display (LCD) devices and organic light-emitting display (OLED) devices, have been widely adopted.

A display device includes a display panel having a plurality of pixels and a panel driver configured to drive the display panel. The panel driver includes a data driver configured to supply a data voltage to the display panel and a gate driver configured to supply a gate signal to the display panel.

However, as display panels increase in size and pixel structures become more complex due to the inclusion of compensation circuits, response speed may deteriorate due to charging delays, thereby degrading image quality.

To improve the response speed of such display panels, an overdriving modulation method is commonly employed. In this method, data from a previous frame is compared with data from a current frame, and image data modulated to a predetermined value is generated based on the comparison result. However, data loss may occur during compression and reconstruction of the previous frame data. Accordingly, there remains a need for a compression and reconstruction method capable of reducing such data loss.

### SUMMARY

Accordingly, the present disclosure is directed to an over driving circuit and a display device including the same that substantially obviates one or more of problems due to limitations and disadvantages described above.

Additional features and advantages of the disclosure will be set forth in the description which follows and in part will be apparent from the description, or may be learned by practice of the disclosure. Other advantages of the present disclosure will be realized and attained by the structure particularly pointed out in the written description and claims hereof as well as the appended drawings.

To achieve these and other advantages and in accordance with the present disclosure, as embodied and broadly described, an over driving circuit may include an encoder configured to generate first compressed data obtained by compressing RGB image data of a previous frame using a first compression algorithm, and to generate second compressed data obtained by compressing the RGB image data using a second compression algorithm; a reconstructor configured to select either the first compressed data or the second compressed data and to synthesize the selected compressed data to thereby generate one piece of integrated compressed data; a decoder configured to reconstruct the generated integrated compressed data to generate integrated reconstructed data; and a modulator configured to modulate image data of a current frame using the generated integrated reconstructed data.

The encoder may include: a first color space converter configured to convert the RGB image data of the previous frame into luminance data and chrominance data; a first compressor configured to generate the first compressed data obtained by compressing each of the converted luminance data and chrominance data using the first compression algorithm; and a second compressor configured to generate the second compressed data obtained by compressing each of the converted luminance data and chrominance data using the second compression algorithm.

The first compressor may be configured to generate the first compressed data by compressing each of the converted luminance data and chrominance data using the first compression algorithm and then multiplying a result of the compression by a predetermined quantization vector (Q).

The reconstructor may include: a first-first reconstructor configured to reconstruct the first compressed data using a first reconstruction algorithm to generate first-first reconstructed data; a first-second reconstructor configured to reconstruct the first compressed data using a second reconstruction algorithm to generate first-second reconstructed data; and a synthesizer configured to select reconstructed data having a smaller error from among the first-first reconstructed data and the first-second reconstructed data and to synthesize compressed data corresponding to the selected reconstructed data to thereby generate the integrated compressed data.

The synthesizer may be configured to calculate a first error sum obtained by summing per-pixel first errors between the first-first reconstructed data and the image data of the previous frame, and a second error sum obtained by summing per-pixel second errors between the first-second reconstructed data and the image data of the previous frame, and to select reconstructed data having a smaller error sum using the first error sum and the second error sum.

The synthesizer is configured not to select reconstructed data having an error greater than a predetermined threshold error between the first error and the second error.

The decoder may include: a second-first reconstructor configured to reconstruct the generated integrated compressed data using a first reconstruction algorithm to generate second-first reconstructed data; a second-second reconstructor configured to reconstruct the generated integrated compressed data using a second reconstruction algorithm to generate second-second reconstructed data; a combiner configured to combine the generated second-first reconstructed data and the second-second reconstructed data to generate the integrated reconstructed data; and a second color space converter configured to convert the generated integrated reconstructed data into RGB reconstructed data.

The over driving circuit may further include a memory configured to store the generated integrated compressed data.

In another aspect of the present disclosure, a display device may include: a display panel in which pixels are arranged in regions where a plurality of gate lines and a plurality of data lines intersect; a gate driver configured to output a gate signal through the gate lines; a data driver configured to output a data voltage through the data lines; and a timing controller configured to control the gate driver and the data driver, wherein the timing controller may include an over driving circuit, and the over driving circuit may include: an encoder configured to generate first compressed data obtained by compressing RGB image data of a previous frame using a first compression algorithm, and to generate second compressed data obtained by compressing the RGB image data using a second compression algorithm; a reconstructor configured to select one of the first compressed data and the second compressed data and to synthesize the selected compressed data to generate one piece of integrated compressed data; a decoder configured to reconstruct the generated integrated compressed data to generate integrated reconstructed data; and a modulator configured to modulate image data of a current frame using the generated integrated reconstructed data.

According to the present disclosure, image data is compressed using different compression algorithms to generate first and second compressed data, compressed data selected from among the generated first and second compressed data is synthesized to generate integrated compressed data, and the generated integrated compressed data is reconstructed, thereby increasing the compression ratio and reducing data loss compared to conventional methods.

According to the present disclosure, boundaries are clearly represented and the color reproduction rate is enhanced, thereby improving image quality.

The effects of the present disclosure are not limited to the effects mentioned above, and other effects not mentioned will be clearly understood by those skilled in the art from the description of the claims.

### BRIEF DESCRIPTION OF THE DRAWINGS

The accompanying drawings, which are included to provide a further understanding of the disclosure and are incorporated in and constitute a part of the disclosure, illustrate aspects of the disclosure and together with the description serve to explain the principle of the disclosure. In the drawings:

FIG. 1 is a diagram illustrating a display device according to an aspect of the present disclosure;

FIGS. 2 to 3 are diagrams illustrating an over driving circuit according to an aspect of the present disclosure;

FIGS. 4 to 10 are diagrams for describing principles of compression and reconstruction of image data;

FIG. 11 is a diagram showing compression and reconstruction performance of image data according to an aspect of the present disclosure; and

FIG. 12 is a diagram illustrating a process of compressing and reconstructing image data according to an aspect of the present disclosure.

DETAILED DESCRIPTION OF EXEMPLARY ASPECTS

The advantages and features of the present disclosure, and methods of achieving them will be apparent from the aspects described in detail below in conjunction with the accompanying drawings. The present disclosure is not limited to the following aspects, which may be implemented in various different forms; rather, the present aspects are provided to make the disclosure of the present disclosure complete and to allow those skilled in the art to fully understand the scope of the present disclosure, and the present disclosure is defined only within the scope of the appended claims.

The shapes, sizes, proportions, angles, numbers and the like shown in the accompanying drawings for the purpose of describing the aspects of the present disclosure are merely examples, and the present disclosure is not limited thereto. Like reference numerals generally denote like elements throughout the present specification. Further, in describing the present disclosure, detailed descriptions of known related technologies may be omitted so as not to unnecessarily obscure the subject matter of the present disclosure.

The terms such as “comprising,” “including,” “having,” and “consisting of” used herein are generally intended to allow other components to be added unless the terms are used with the term “only.” References to the singular shall be construed to include the plural unless expressly stated otherwise.

In the interpretation of components, they are construed to include margins of error, even if not explicitly stated.

When describing a positional or interconnected relationship between two components, such as “on top of,” “above,” “below,” “next to,” “connect or couple with,” “crossing,” “intersecting,” etc., one or more other components may be interposed between them unless “immediately” or “directly” is used.

When describing a temporal contextual relationship, such as “after,” “following,” “next to,” or “before,” it may not be continuous on a time scale unless “immediately” or “directly” is used.

First, second, and the like may be used before the names of the components to distinguish the components, but the function or structure thereof is not limited by such ordinal number or component name. For ease of description, the ordinal numbers placed before the names of the same components may differ between aspects.

The following aspects may be combined or associated with each other in whole or in part, and various types of interlocking and driving are technically possible. The aspects may be implemented independently of one another or may be implemented together in an interrelated relationship.

Hereinafter, various aspects of the present disclosure will be described in detail with reference to the accompanying drawings.

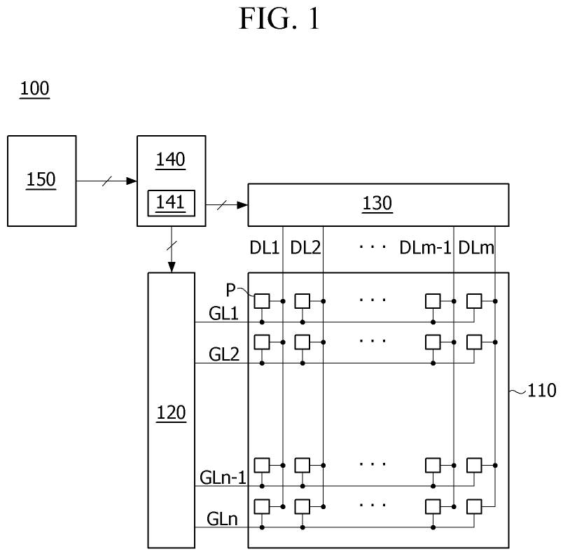

FIG. 1 is a diagram illustrating a display device according to an aspect of the present disclosure.

Referring to FIG. 1, a display device 100 according to an aspect of the present disclosure may include a display panel 110 and a display driving circuit configured to drive the display panel 110. The display driving circuit may include a gate driver 120, a data driver 130, and a timing controller 140. The display device 100 may further include a host system 150 configured to supply various timing signals to the timing controller 140.

The display panel 110 may include a plurality of gate lines GL1 to GLn and a plurality of data lines DL1 to DLm arranged to cross each other to define a plurality of pixel regions, and pixels P provided respectively in the plurality of pixel regions.

Each of the pixels P may be divided into a red sub-pixel emitting red light, a green sub-pixel emitting green light, and a blue sub-pixel emitting blue light for color implementation, but the present disclosure is not limited thereto.

The gate driver 120 may be disposed on one side of the display panel 110, for example, on the left side as shown, but in some cases may be disposed on both one side and the other side of the display panel 110 facing each other, for example, on both the left and right sides. The gate driver 120 may include a plurality of gate driver ICs (Gate Driver Integrated Circuits) (not shown).

The gate driver 120 may be configured in the form of a tape carrier package on which gate driver ICs are mounted, but is not necessarily limited thereto, and the gate driver ICs may be directly mounted on the display panel 110.

The data driver 130 converts digital image data transmitted from the timing controller 140 into an analog data voltage and outputs the analog data voltage to the display panel 110. Specifically, the data driver 130 outputs an analog data voltage to the data lines DL1 to DLm in response to a data control signal (DCS) transmitted from the timing controller 140.

The data driver 130 may be disposed on one side of the display panel 110, for example, on the upper side, but in some cases may be disposed on both one side and the other side of the display panel 110 facing each other, for example, on both the upper and lower sides of the display panel. In addition, the data driver 130 may be configured in the form of a tape carrier package on which source driver ICs (Source Driver Integrated Circuits) are mounted, but is not necessarily limited thereto.

The timing controller 140 may receive various timing control signals including a vertical synchronization signal (Vsync), a horizontal synchronization signal (Hsync), a data enable (DE) signal, and a clock signal (CLK) from the host system 150, and may generate a data control signal (DCS) for controlling the data driver 130 and a gate control signal (GCS) for controlling the gate driver 120.

In addition, the timing controller 140 may receive image data from the host system 150, convert the received image data into a form suitable for processing by the data driver 130, and output the converted image data. When there is a difference between image data of a previous frame and image data of a current frame, the timing controller 140 may output image data modulated according to the difference. When there is no difference between the image data of the previous frame and the image data of the current frame, the timing controller 140 may output the image data of the current frame without modification.

The data control signal (DCS) may include a source start pulse (SSP), a source sampling clock (SSC), and a source output enable signal (SOE). The gate control signal (GCS) may include a gate start pulse (GSP), a gate shift clock (GSC), and a gate output enable signal (GOE).

The host system 150 may be implemented as any one of a navigation system, a set-top box, a DVD player, a Blu-ray player, a personal computer (PC), a home theater system, a broadcast receiver, and a phone system.

The host system 150 may include a SoC (System on Chip) having a built-in scaler, and may convert digital image data (RGB) of an input image into a format suitable for display on the display panel 110 and output the converted digital image data. The host system 150 may transmit the converted digital image data of the input image and various timing control signals to the timing controller 140.

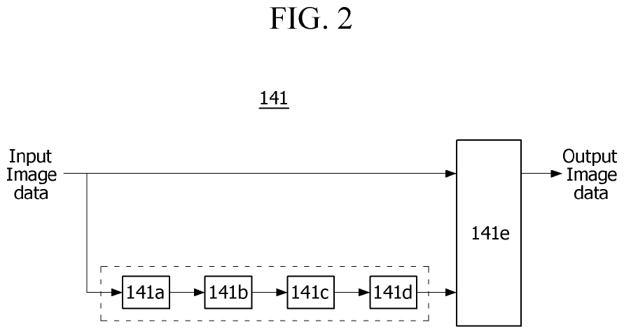

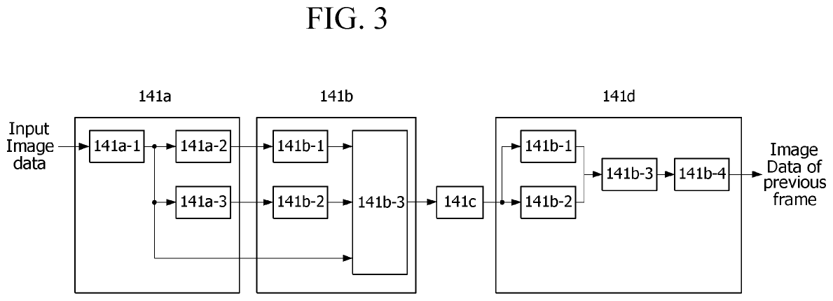

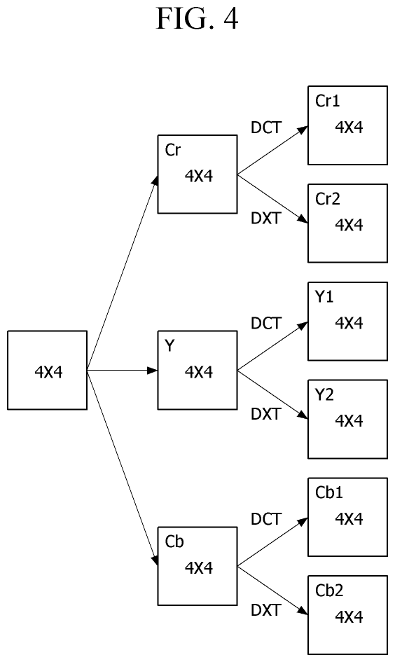

FIGS. 2 to 3 are diagrams illustrating an over driving circuit according to an aspect of the present disclosure, and FIGS. 4 to 10 are diagrams for describing principles of compression and reconstruction of image data.

Referring to FIGS. 2 to 3, an over driving circuit 141 according to an aspect of the present disclosure may include an encoder 141a, a reconstructor 141b, a memory 141c, a decoder 141d, and a modulator 141e.

The encoder 141a may compress image data input in units of frames. The encoder 141a may divide the image data into blocks of a predetermined size, generate first compressed data by compressing the image data on a block-by-block basis using a first compression algorithm, and generate second compressed data by compressing the image data using a second compression algorithm. Herein, the first compression algorithm may be DCT (Discrete Cosine Transform) and the second compression algorithm may be DXT (DirectX Texture), but are not limited thereto.

The encoder 141a may include a first color space converter 141a-1, a first compressor 141a-2, and a second compressor 141a-3.

The first color space converter 141a-1 may divide RGB image data into blocks of a predetermined size and convert the image data on a block-by-block basis into luminance data (Y) and chrominance data (Cb, Cr). The reason for performing the color space conversion in this manner is to improve compression efficiency.

The first compressor 141a-2 may compress the luminance data (Y) and chrominance data (Cb, Cr) on a block-by-block basis, wherein each block includes a predetermined plurality of pixels, using the first compression algorithm to generate first compressed data, and may provide the first compressed data to the reconstructor 141b. As shown in FIG. 4, the first compressor 141a-2 may compress the luminance data (Y) and chrominance data (Cb, Cr) on a block-by-block basis, each block including 4×4 pixels, to generate first compressed data (Y1, Cb1, Cr1). Although a 4×4 block is described herein as an example, the present disclosure is not limited thereto.

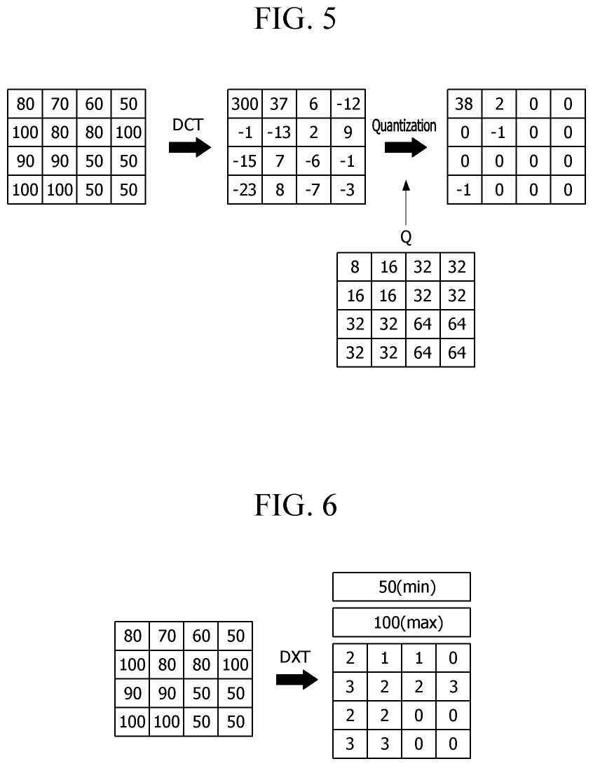

As shown in FIG. 5, the first compressor 141a-2 may compress each of the luminance data (Y) and chrominance data (Cb, Cr) using the first compression algorithm, and then multiply a predetermined quantization vector (Q) to generate first compressed data. The reason for multiplying the compressed data by the predetermined quantization vector (Q) in this manner is to simplify the compressed data. Here, the first compressed data may include the compressed luminance data (Y) and chrominance data (Cb, Cr).

In this case, the compressed data C (u) obtained using the first compression algorithm is defined as the following Equation 1:

$$C ( u ) = a ( u ) {\sum }_{x = 0}^{N - 1} f ( x ) cos [ \frac{( 2 x + 1 ) u π}{2 N} ]$$

$$where u = 0 , 1 , … , N - 1 , and$$

$$a ( u ) = \{ \begin{matrix}\sqrt{\begin{matrix}\frac{1}{N} & & & & & & u = 0\end{matrix}} \\ \sqrt{\frac{2}{N}} u = 1 , … , N - 1\end{matrix}$$

Here, f(x) is original image data before conversion, and N represents the number of blocks.

The second compressor 141a-3 may compress each of the luminance data (Y) and chrominance data (Cb, Cr) on a block-by-block basis, each block including a predetermined plurality of pixels, using the second compression algorithm to generate second compressed data, and may provide the second compressed data to the reconstructor 141b. For example, the second compressor 141a-3 may compress the image data on a block-by-block basis, each block including 4×4 pixels, using the second compression algorithm to generate second compressed data (Y2, Cb2, Cr2).

As shown in FIG. 6, the second compressor 141a-3 may compress the luminance data (Y) and chrominance data (Cb, Cr) to generate the second compressed data including a minimum average value, a maximum average value, and a bitmap. Here, the second compressed data may include the compressed luminance data (Y) and chrominance data (Cb, Cr).

To elaborate, the average value of the luminance values or the chrominance values for the 16 pixels is obtained, and the pixels are divided into an upper group and a lower group based on the average value. Based on the average of the upper group, the upper group is further divided into a first upper group {100, 100, 100, 90} and a second upper group {80, 70, 70}, and based on the average of the lower group, the lower group is further divided into a first lower group {50, 50, 50, 30} and a second lower group {20, 20, 10, 0, 0}. The average value of 98 for the first upper group may serve as the maximum average value, and the average value of 10 for the second lower group may serve as the minimum average value.

In this case, ‘3’ may be assigned to the first upper group, ‘2’ may be assigned to the second upper group, ‘1’ may be assigned to the first lower group, and ‘0’ may be assigned to the second lower group, based on which the bitmap may be generated.

The luminance data (Y) and chrominance data (Cb, Cr) converted by the first color space converter 141a-1 may be provided not only to the first compressor 141a-2 and the second compressor 141a-3 but also to the reconstructor 141b.

The reconstructor 141b may select one of the provided first compressed data and second compressed data on a block-by-block basis and synthesize the selected data to generate one piece of integrated compressed data.

The reconstructor 141b may include a first-first reconstructor 141b-1, a first-second reconstructor 141b-2, and a synthesizer 141b-3.

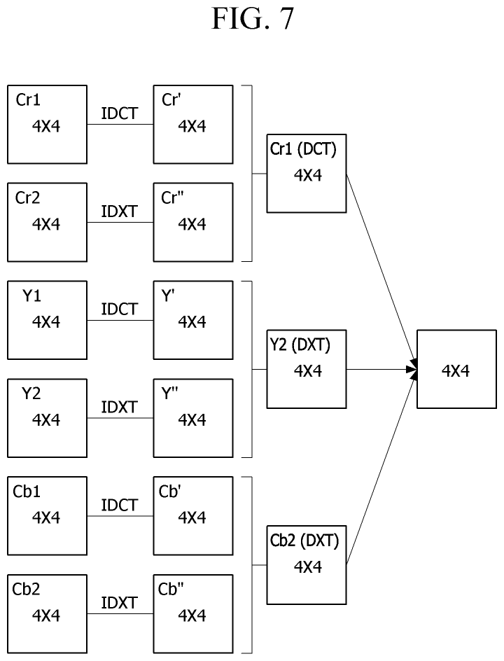

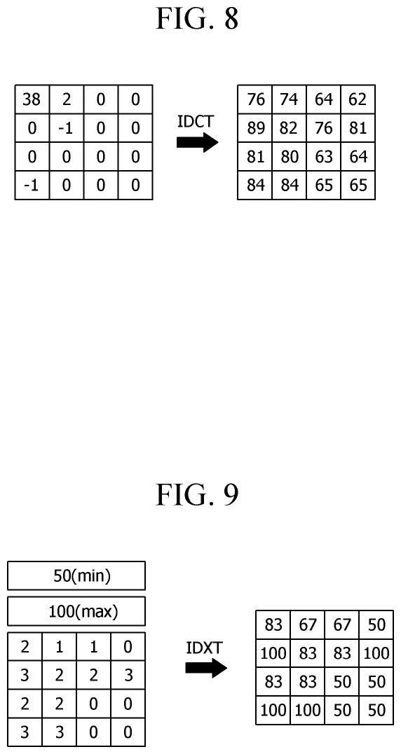

As shown in FIG. 7, the first-first reconstructor 141b-1 may reconstruct the first compressed data on a block-by-block basis using the first reconstruction algorithm to generate first-first reconstructed data (Cr′, Y′, Cb′). For example, when the compressed data of FIG. 5 is reconstructed, the reconstructed data shown in FIG. 8 may be generated.

The first-second reconstructor 141b-2 may reconstruct the second compressed data on a block-by-block basis using the second reconstruction algorithm to generate first-second reconstructed data (Cr″, Y″, Cb″). For example, when the compressed data of FIG. 6 is reconstructed, the reconstructed data shown in FIG. 9 may be generated.

The synthesizer 141b-3 may select one piece of data (Cr′, Y″, Cb″) from among the first-first reconstructed data and the first-second reconstructed data, and synthesize the compressed data (Cr1, Y2, Cb2) corresponding to the selected data (Cr′, Y″, Cb″) to generate one piece of integrated compressed data.

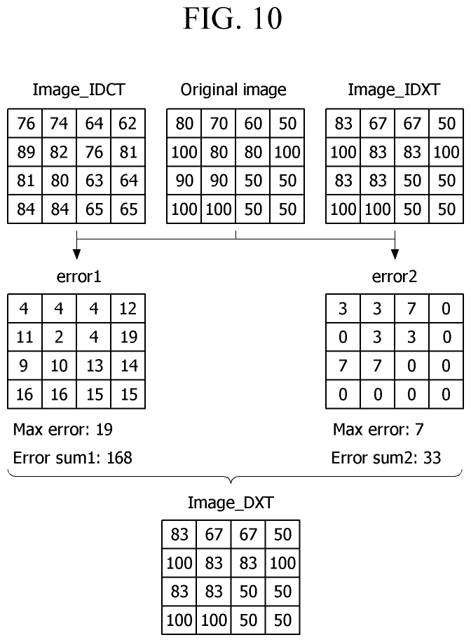

To be more specific, as shown in FIG. 10, the synthesizer 141b-3 may compare the first-first reconstructed data “Image_IDCT” with the original image data “Original image” on a pixel-by-pixel basis to calculate per-pixel first errors “error1” and a first error sum “error sum1” obtained by summing the per-pixel first errors “error1”, and may compare the first-second reconstructed data “Image_IDXT” with the original image data “Original image” on a pixel-by-pixel basis to calculate per-pixel second errors “error2” and a second error sum “error sum2” obtained by summing the per-pixel second errors “error2”.

The synthesizer 141b-3 may check whether any value exceeding a predetermined threshold error exists among the per-pixel first errors “error1” and per-pixel second errors “error2”, and may exclude a block in which a value exceeding the threshold error is calculated from targets used for reconstructing the compressed data. The threshold error may be ‘50’, which is the difference between the maximum value ‘100’ and the minimum value ‘50’ for the original image data. Here, since the maximum value of the first error “error1” is 19 and the maximum value of the second error “error2” is 7, neither of the two pieces of reconstructed data is excluded from the targets. This is because even if the error sum is relatively small, a pixel with an excessively large error may be included, and such a pixel is to be excluded.

The synthesizer 141b-3 may select the compressed data “Image_DXT” corresponding to the first-second reconstructed data “Image_IDXT” for which the smaller second error sum “error sum2” was calculated among the calculated first error sum “error sum1” and second error sum “error sum2”, and may synthesize the selected compressed data. In this case, since the compressed data compressed using different compression algorithms is synthesized, an identifier for identifying the first and second compression algorithms may be assigned to the compressed data.

The synthesizer 141b-3 may store the integrated compressed data synthesized thereby in the memory 141c. The synthesized integrated compressed data stored in the memory 141c may be the image data of the current frame.

The memory 141c may store the integrated compressed data synthesized by the synthesizer 141b-3 and may provide the stored integrated compressed data to the decoder 141d with a delay of one frame period.

The decoder 141d may reconstruct the integrated compressed data stored in the memory 141c to generate integrated reconstructed data. The decoder 141d may reconstruct at least a portion of the compressed data using a first reconstruction algorithm based on the identifier assigned on a block-by-block basis to generate second-first reconstructed data, and may reconstruct the remainder using a second reconstruction algorithm to generate second-second reconstructed data. Here, the first reconstruction algorithm may be IDCT (Inverse Discrete Cosine Transform) and the second reconstruction algorithm may be IDXT (Inverse DirectX Texture).

The decoder 141d may include a second-first reconstructor 141d-1, a second-second reconstructor 141d-2, a combiner 141d-3, and a second color space converter 141d-4.

The second-first reconstructor 141d-1 may reconstruct the received integrated compressed data on a block-by-block basis using the first reconstruction algorithm to generate second-first reconstructed data.

The second-second reconstructor 141d-2 may reconstruct the received compressed data on a block-by-block basis using the second reconstruction algorithm to generate second-second reconstructed data.

The combiner 141d-3 may combine the second-first reconstructed data and the second-second reconstructed data to generate one piece of integrated reconstructed data.

The second color space converter 141d-4 may convert the generated YCbCr integrated reconstructed data into RGB reconstructed data on a block-by-block basis and provide the converted RGB reconstructed data to the modulator 141e. Here, the reconstructed data provided to the modulator 141e may be provided as data of the previous frame because it is provided with a delay of one frame period.

The modulator 141e may compare the previous frame data with the current frame data, and output modulated image data corresponding to the difference value obtained from the comparison result. For example, the modulator 141e may output the modulated image data corresponding to the difference value based on a predetermined look-up table. The modulator 141e may output the current frame data without modulation when the previous frame data and the current frame data are the same.

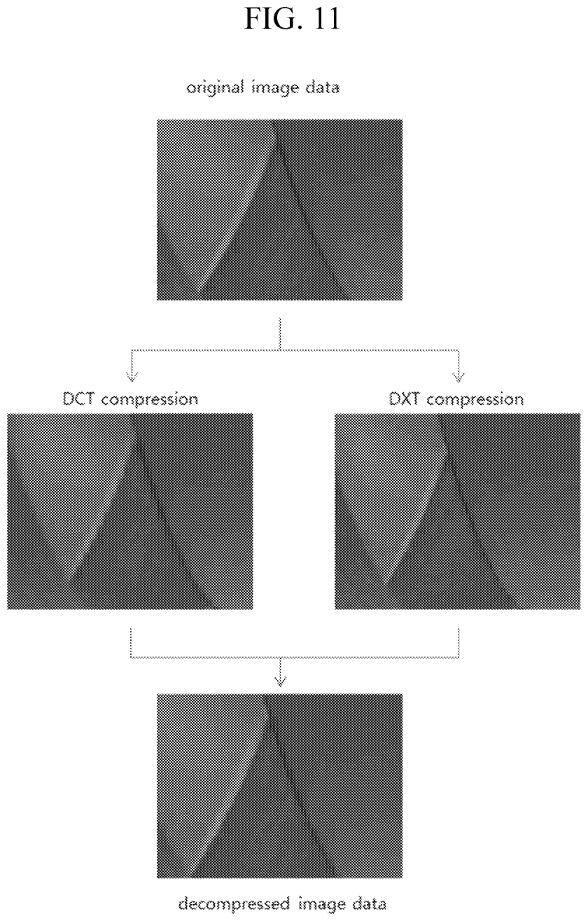

FIG. 11 is a diagram showing compression and reconstruction performance of image data according to an aspect of the present disclosure.

Referring to FIG. 11, it can be seen that the first compressed data, obtained by compressing the original image data using the first compression algorithm (DCT), exhibits good color reproduction rate but suffers from blurring at boundaries, whereas the second compressed data, obtained by compressing the original image data using the second compression algorithm (DXT), has boundaries that are well represented but exhibits degraded color reproduction rate.

By selecting one of the first compressed data and the second compressed data, synthesizing it and then reconstructing the synthesized image data, it can be seen that boundaries are clearly represented and color reproduction rate is improved.

The first compression algorithm is advantageous for low-frequency images, whereas the second compression algorithm is advantageous for high-frequency images, and thereby enabling improved image quality by utilizing the advantages of both algorithms.

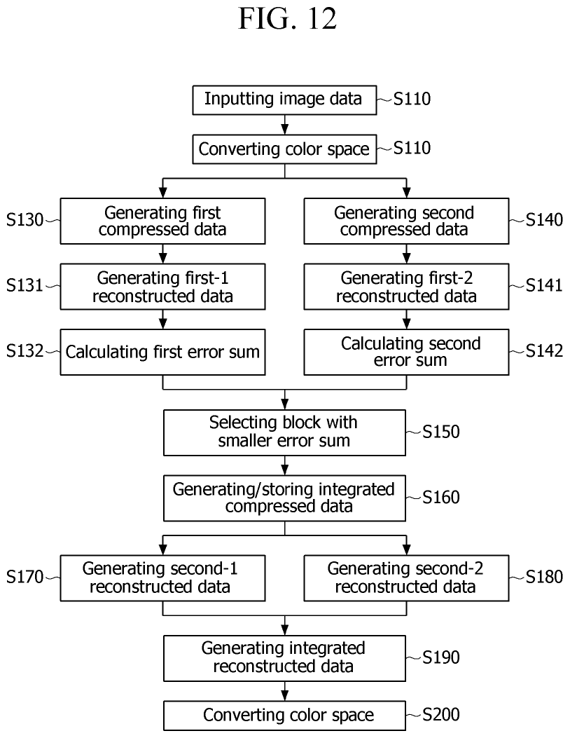

FIG. 12 is a diagram illustrating a process of compressing and reconstructing image data according to an aspect of the present disclosure.

Referring to FIG. 12, the encoder according to an aspect of the present disclosure receives RGB image data (S110), and may convert the received RGB image data into luminance data and chrominance data (S120).

The encoder may compress the luminance data and chrominance data on a block-by-block basis using the first compression algorithm to generate first compressed data (S130), and may compress the luminance data and chrominance data using the second compression algorithm to generate second compressed data (S140).

The reconstructor may reconstruct the first compressed data on a block-by-block basis using the first reconstruction algorithm to generate first-first reconstructed data (S131), and may reconstruct the second compressed data on a block-by-block basis using the second reconstruction algorithm to generate first-second reconstructed data (S141).

The reconstructor may calculate a first error sum by comparing the first reconstructed data with the original image data on a pixel-by-pixel basis and summing the per-pixel first errors (S132), and may calculate a second error sum by comparing the second reconstructed data with the original image data on a pixel-by-pixel basis and summing the per-pixel second errors (S142).

The reconstructor may select a block with a smaller error sum (S150), generate integrated compressed data using the selected blocks, and store the generated integrated compressed data in a memory (S160).

The decoder may reconstruct the integrated compressed data on a block-by-block basis using the first reconstruction algorithm to generate second-first reconstructed data (S170), and may reconstruct the integrated compressed data using the second reconstruction algorithm to generate second-second reconstructed data (S180).

The decoder may combine the second-first reconstructed data and the second-second reconstructed data to generate one piece of integrated reconstructed data (S190), and may convert the integrated reconstructed data generated thereby into RGB reconstructed data (S200).

While aspects have been described in more detail with reference to the accompanying drawings, the present disclosure is not necessarily limited to these aspects and may be practiced in various modifications without departing from the spirit of the present disclosure. Therefore, the aspects disclosed in the present disclosure are provided for illustrative purposes only and are not intended to limit the technical concept of the present disclosure, and the scope of the technical concept of the present disclosure is not limited thereto. Thus, it is intended that the present disclosure covers the modifications and variations of the aspects provided they come within the scope of the appended claims and their equivalents.

What is claimed is:

1. An over driving circuit comprising:
an encoder configured to generate first compressed data obtained by compressing RGB image data of a previous frame using a first compression algorithm, and to generate second compressed data obtained by compressing the RGB image data using a second compression algorithm;
a reconstructor configured to select either the first compressed data or the second compressed data and to synthesize the selected compressed data to thereby generate one piece of integrated compressed data;
a decoder configured to reconstruct the generated integrated compressed data to generate integrated reconstructed data; and
a modulator configured to modulate image data of a current frame using the generated integrated reconstructed data.

2. The over driving circuit according to claim 1, wherein the encoder comprises:
a first color space converter configured to convert the RGB image data of the previous frame into luminance data and chrominance data;
a first compressor configured to generate the first compressed data obtained by compressing each of the converted luminance data and chrominance data using the first compression algorithm; and
a second compressor configured to generate the second compressed data obtained by compressing each of the converted luminance data and chrominance data using the second compression algorithm.

3. The over driving circuit according to claim 2, wherein the first compressor is configured to generate the first compressed data by compressing each of the converted luminance data and chrominance data using the first compression algorithm and then multiplying a result of the compression by a predetermined quantization vector (Q).

4. The over driving circuit according to claim 2, wherein the reconstructor comprises:
a first-first reconstructor configured to reconstruct the first compressed data using a first reconstruction algorithm to generate first-first reconstructed data;
a first-second reconstructor configured to reconstruct the second compressed data using a second reconstruction algorithm to generate first-second reconstructed data; and
a synthesizer configured to select reconstructed data having a smaller error from among the first-first reconstructed data and the first-second reconstructed data and to synthesize compressed data corresponding to the selected reconstructed data to thereby generate the integrated compressed data.

5. The over driving circuit according to claim 4, wherein the synthesizer is configured to calculate a first error sum obtained by summing per-pixel first errors between the first-first reconstructed data and the image data of the previous frame, and a second error sum obtained by summing per-pixel second errors between the first-second reconstructed data and the image data of the previous frame, and to select reconstructed data that has a smaller error sum using the first error sum and the second error sum.

6. The over driving circuit according to claim 5, wherein the synthesizer is configured not to select reconstructed data that has an error greater than a predetermined threshold error between the first error and the second error.

7. The over driving circuit according to claim 4, wherein the decoder comprises:
a second-first reconstructor configured to reconstruct the generated integrated compressed data using a first reconstruction algorithm to generate second-first reconstructed data;
a second-second reconstructor configured to reconstruct the generated integrated compressed data using a second reconstruction algorithm to generate second-second reconstructed data;
a combiner configured to combine the generated second-first reconstructed data and the second-second reconstructed data to generate the integrated reconstructed data; and
a second color space converter configured to convert the generated integrated reconstructed data into RGB reconstructed data.

8. The over driving circuit according to claim 4, wherein:
the first compression algorithm is DCT (Discrete Cosine Transform) and the second compression algorithm is DXT (DirectX Texture), and
the first reconstruction algorithm is IDCT (Inverse DCT) and the second reconstruction algorithm is IDXT (Inverse DXT).

9. The over driving circuit according to claim 1, further comprising a memory configured to store the generated integrated compressed data.

10. A display device comprising:
a display panel in which pixels are arranged in regions where a plurality of gate lines and a plurality of data lines intersect;
a gate driver configured to output a gate signal through the gate lines;
a data driver configured to output a data voltage through the data lines; and
a timing controller configured to control the gate driver and the data driver,
wherein the timing controller includes an over driving circuit, and
wherein the over driving circuit comprises:
an encoder configured to generate first compressed data obtained by compressing RGB image data of a previous frame using a first compression algorithm, and to generate second compressed data obtained by compressing the RGB image data using a second compression algorithm;
a reconstructor configured to select either the first compressed data or the second compressed data and to synthesize the selected compressed data to thereby generate one piece of integrated compressed data;
a decoder configured to reconstruct the generated integrated compressed data to generate integrated reconstructed data; and
a modulator configured to modulate image data of a current frame using the generated integrated reconstructed data.

11. The display device according to claim 10, wherein the encoder comprises:
a first color space converter configured to convert the RGB image data of the previous frame into luminance data and chrominance data;
a first compressor configured to generate the first compressed data obtained by compressing each of the converted luminance data and chrominance data using the first compression algorithm; and
a second compressor configured to generate the second compressed data obtained by compressing each of the converted luminance data and chrominance data using the second compression algorithm.

12. The display device according to claim 11, wherein the reconstructor comprises:
a first-first reconstructor configured to reconstruct the first compressed data using a first reconstruction algorithm to generate first-first reconstructed data;
a first-second reconstructor configured to reconstruct the second compressed data using a second reconstruction algorithm to generate first-second reconstructed data; and
a synthesizer configured to select reconstructed data having a smaller error from among the first-first reconstructed data and the first-second reconstructed data and to synthesize compressed data corresponding to the selected reconstructed data to thereby generate the integrated compressed data.

13. The display device according to claim 12, wherein the synthesizer is configured to calculate a first error sum obtained by summing per-pixel first errors between the first-first reconstructed data and the image data of the previous frame, and a second error sum obtained by summing per-pixel second errors between the first-second reconstructed data and the image data of the previous frame, and to select reconstructed data that has a smaller error sum using the first error sum and the second error sum.

14. The display device according to claim 13, wherein the synthesizer is configured to not select reconstructed data that has an error greater than a predetermined threshold error among the first error and the second error.

15. The display device according to claim 12, wherein the decoder comprises:
a second-first reconstructor configured to reconstruct the generated integrated compressed data using a first reconstruction algorithm to generate second-first reconstructed data;
a second-second reconstructor configured to reconstruct the generated integrated compressed data using a second reconstruction algorithm to generate second-second reconstructed data;
a combiner configured to combine the generated second-first reconstructed data and the second-second reconstructed data to generate the integrated reconstructed data; and
a second color space converter configured to convert the generated integrated reconstructed data into RGB reconstructed data.
